(19) United States
(12) Patent Application Publication
(10) Pub. No.: US 2008/0309886 A1
(43) Pub. Date: Dec. 18, 2008

(54) Controllable Light Monitor Element and Device For Use

(76) Inventor: Uwe Prochnow, Essen (DE)

Correspondence Address: BROWDY AND NEIMARK, P.L.L.C.;624 NINTH STREET, NW, SUITE 300, WASHINGTON, DC, 20001-5303, US

(21) Appl. No.: 12/091,879

(22) PCT Filed: Oct. 27, 2006
(86) PCT No.: PCT/EP2006/067845

§ 371 Date: Aug. 11, 2008

(30) Foreign Application Priority Data
Oct. 28, 2005 (EP) 05110129.3

(51) Int. Cl. G02F 1/01; G02B 26/08; G03B 21/14

(52) U.S. Cl. 353/31; 359/240; 359/211

(57) ABSTRACT

The invention relates to a controllable light modulator (M) whose transmission can be controlled by the intensity of electric fields, wherein it is exposed to an intensity-controlled microwave field. Furthermore a device for laser projection is illustrated which is controlled by a light modulator of this kind.

The invention relates to a controllable a light modulator element with a light passage whose light transmission can be controlled by the intensity of electromagnetic fields; and to its use, especially in a colour imaging device.

It is well known to direct light through a polarizable medium, the polarization properties of which can be changed by an electric or magnetic field—a so-called Kerr-cell—, and through an unchanging polarization filter. In dependence on the control of the cell, more or less light passes these polarizers. Such Kerr cells require high electric control voltages or strong magnetic fields, the generation of which is relatively expensive, and they switch back to their original state with a considerable delay, when the electric or magnetic excitation is withdrawn. In addition, a substantial energy turnover is implemented in the medium, if the excitation is changed at a high frequency.

Furthermore, colour imaging devices are known which employ three intensity-controlled light sources of different colours, the light of which is superimposed and displayed on a screen by means of moving X- Y-deflectors.

Furthermore, solids are known, e.g. those implemented in welder's protective goggles, which are dimmed by incoming light depending on its intensity, so that their transmission strongly decreases with increasing light intensity. This effect has a very short relaxation time. Flashing lights do not pass through such a pane, but afterwards it is transparent again.

It is the aim of the invention to create a controllable high-speed light modulator.

The solution resides in that the light passage of the light modulator element is exposed to an intensity-controlled microwave field.

Advantageous embodiments and implementations are indicated in the subclaims.

The new light modulator element is particularly suitable for controlling the intensity of a laser beam. The modulator element can miniaturized due to the small diameter of a laser beam. The light passage of the light modulator element is made of glass, the transmission capacity of which can be controlled by the intensity of an alternating electromagnetic field. The frequency and strength of the alternating field depends on manufacturing parameters of the glass. So far, these glasses are employed in spectacles such as sunglasses or welder's goggles, in which the transparency (light transmission) depends on the brightness of the light that is applied. Now this glass can also be manufactured in such a way that instead of being controlled by light, the transmission is controlled by electromagnetic fields with a defined frequency, which is lower than the frequency of light radiation. Typically, this is a frequency between 5 and 100 GHz. The transmission of the glass directly depends on the applied field strength. This way, even microwave fields can be used to control the transmission of the light modulator.

In a preferential embodiment, microwave antennas are arranged in pairs on one or both sides of the modulator element. A circular arrangement of antennas with alternating polarity has proven particularly successful. A quadrupolar field, an octopolar field, or the like, is thus generated around a central light passage, which only needs to be slightly larger than the modulating light beam.

In another execution the glass has a cylindrical shape and the antenna electrodes are shaped as rings around the glass cylinder. The electrodes employed for a microwave frequency of e.g. 50 GHz are only millimetres in size.

Preferably, the electrode pairs are parts of capacitors, which generate resonant circuits with inductive resistors arranged around the modulator element. High field strengths result, due to the limited thickness of the glass and the small gap between the electrodes. The field strengths in the central light passage are further increased if the phases of the resonant circuits are triggered in a staggered way, so that the respective maximum phase rotates around the central light passage.

The light modulator can be operated with frequencies up to 180 GHz if it is appropriately constructed. This frequency can serve as a carrier frequency, which is modulated by a control frequency.

The intensity of a 50-GHz generator, for example, can be controlled by a frequency of 5 GHz, and that frequency is also used for the transmission of the light modulator element for a light beam or a laser beam. A beam of a continuously operated laser that is controlled in this way can be brought to varied uses, e.g. for an analogue or digital message transmission, to record information, for material processing or, as described in more detail, for image display. This method for modulating a continuously operated laser avoids all known disadvantages of pulsed lasers.

In a monochrome imaging device, a laser beam is directed through the light modulator element, either directly or after its colour has been modified by a filter, e.g. changed to white light. Then it is directed to one and then another rotating prism mirror for X- and Y-deflection, and projected onto a screen, where it creates an image in accordance with the modulation of the light. To produce a video image, the control microwave is operated with a monochrome video signal modulation and the rotating metallized prisms are synchronized with the line- and image-change signal.

Accordingly, a colour television image is generated by directing to the prisms three superimposed modulated laser beams of different colours, which are modulated according to the colour signals, i.e. the higher the colour signal the lower the respective microwave energy.

In an advantageous embodiment, a white light beam is modulated according to a luminance signal and added to the three colour laser beams before they pass the prism. The white light beam is generated, in a known simple way, from a blue laser beam by modification in a yellow filter. The brightness of a projected image can be controlled by this additional luminance signal, without having to change the output of the colour lasers. Thus, colour shifts are avoided, that could otherwise occur—due to the nonlinearity of the lasers—when the brightness of the image changes.

A complete colour image projector of this type is accommodated in a 3 cm thick casing of DIN A5 dimensions and provides about 15 k Lumen. Due to the high modulation frequency of 5 GHz that can be attained, images of 10 mega pixel at a picture repetition rate of 250 Hz can be generated with unprecedented quality and brilliance.

In the figures, an execution of the invention is presented by way of example.

FIG. 1 shows a schematic view of a light modulator

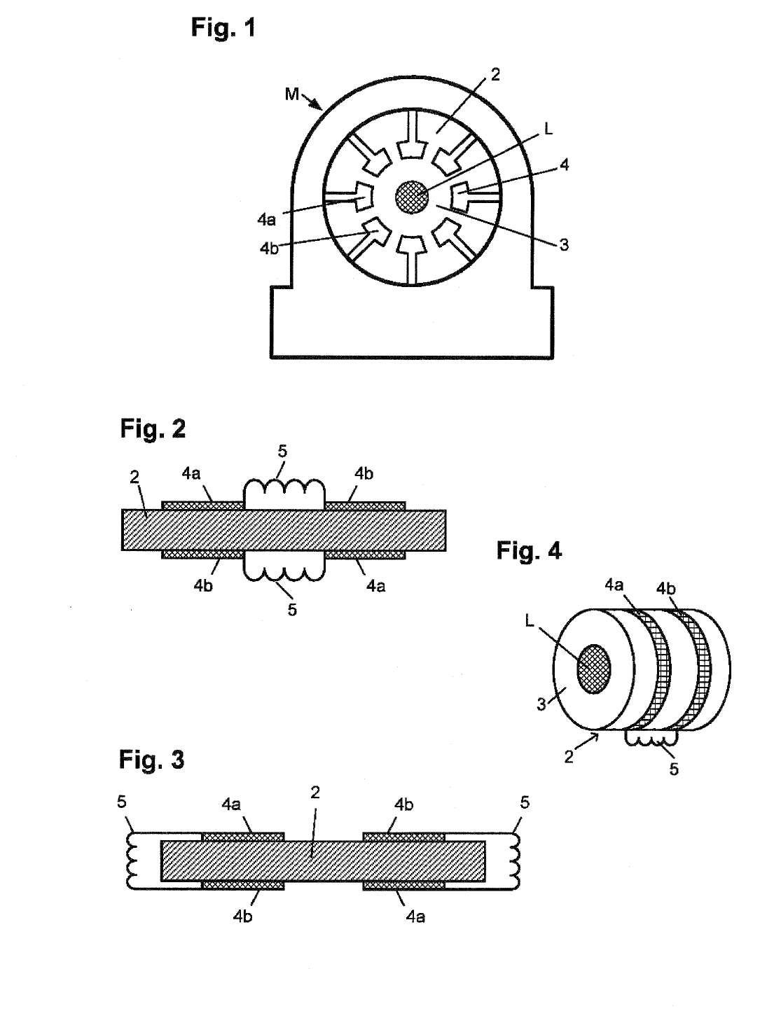

FIG. 2 shows a first electrode arrangement

FIG. 3 shows a second electrode arrangement

FIG. 4 shows a cylindrical arrangement

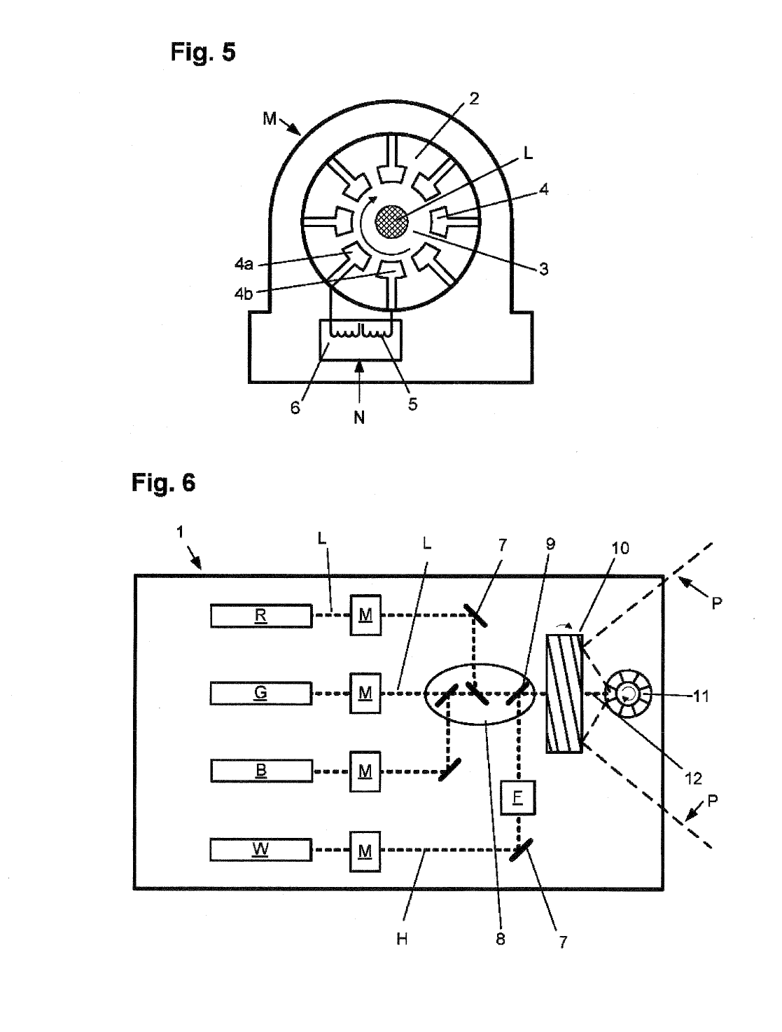

FIG. 5 shows a light modulator with generator

FIG. 6 shows a schematic view of a laser projector

In FIG. 1 a light modulator M is depicted schematically, in which a central pane 2 is held. In the area of light passage 3 a laser beam L passes the pane.

The circular antenna electrodes 4 are arranged on the pane 2, with respectively two electrodes 4a, 4b forming a pair of electrodes. The electric field strength is applied to the glass 2 by these electrodes 4a, 4b, which are part of a microwave resonant circuit, and the transmission of the glass 2 is controlled.

Furthermore, the electrodes 4 serve to eliminate loss heat from the glass.

FIG. 2 shows a first arrangement of electrodes 4a, 4b on the pane 2. In this arrangement, respectively one pair of electrodes 4a, 4b is placed on each side of the glass 2, forming a microwave resonant circuit with the inductor 5. Because there is also a resonant circuit on the other side, a quadrupolar field is generated. It is also possible that the electrodes 4a, 4b are disposed only on one side of the glass 2, so that dipole fields result.

FIG. 3 shows a second arrangement of electrodes 4a, 4b on the pane 2. In this arrangement, electrodes 4a, 4b on opposite sides of the glass 2 form pairs and form a microwave resonant circuit with the inductor 5. Because of adjacent resonant circuits, a multipolar field is generated.

FIG. 4 depicts a light modulator element in cylindrical shape. The two antenna electrodes 4a and 4b are laid in a ring around the glass cylinder. They form the plates of a capacitor, which forms a resonant circuit with the inductor 5, and between the electrodes of which an alternating field results accordingly. This alternating field controls the laser beam L, which is directed the axially through the glass cylinder 2.

FIG. 5 is once again the schematic view of the modulator M according to FIG. 1. The electrodes 4 on the pane 2 are activated by a corresponding number of generators 6, of which only one is represented. Each generator 6 feeds a circuit consisting of the inductors 5 and the electrodes 4a, 4b. The intensity of the resulting microwave field is controlled in accordance with the wanted signal N. The phase of the generators 6 is controlled in such a way, that a rotating field is formed on the pane 2, represented here by an arrow. This rotating field produces a continuous control of the transmission in the light passage 3 for the laser beam L.

In FIG. 6, a projector 1 with colour lasers R, G, B, W and modulators M is shown schematically. The modulators M for the colour laser R, G, B, are controlled in a known manner according to the colour signals of an image (not shown here) and are combined to a colour beam by mirrors 7 and prisms in the light superimposition 8. The beam of the laser W, which is blue at first, is modulated in the corresponding modulator M, according to a luminance signal. This luminance signal H is changed to a white beam in a filter F and added to the colour beam 12 by the prism 9. The brightness of the resulting image can be set by appropriate modulation of the light signal H, without readjusting the colour lasers R, G, B.

The colour beam 12 is deflected horizontally by the rotating metallized prism cylinder 11, and deflected vertically by the rotating metallized prism cylinder 10, in a known manner. The surfaces of the prisms are inclined in such a way that the projection beam P takes a straight course to the projection screen.

### REFERENCES

1 projector
2 pane
3 light passage
4 electrode
4a first electrode
4b second electrode
5 inductor
6 generator
7 mirror
8 light superposition
9 luminance input
10 vertical metallized prism cylinder
11 horizontal metallized prism cylinder
12 superimposed beam
B blue laser
F filter
G green laser
H luminance signal
L laser beam
M light modulator
N wanted signal
P projection beam
R red laser
W white laser

1. Light modulator (M) with a light passage whose light transmission can be controlled by the intensity of electromagnetic fields, characterized in that it is exposed to an intensity-controlled microwave field.

2. Light modulator according to claim 1, characterized in that the light passage is made of glass.

3. Light modulator according to claim 2, characterized in that the glass is designed in such a way that the light transmission characteristic is essentially determined by a microwave field in a specific frequency range.

4. Light modulator according to claim 3, characterized in that the microwave field has a defined frequency between 5 and 180 GHz.

5. Light modulator according to claim 4, characterized in that the microwave frequency serves as a carrier frequency the amplitude of which is modulated up to a frequency, that is approximately one order below the microwave frequency.

6. Light modulator according to claim 2, characterized in that microwave antennas (4a, 4b) are arranged in pairs around the light passage (3) on one side or on several sides of the glass, with alternating polarity.

7. Light modulator according to claim 6, characterized in that the light passage (3) has a diameter which is slightly larger than that of a laser beam to be modulated.

8. Light modulator according to claim 6 characterized in that said that the planar antenna electrodes (4a, 4b) function as capacitors and form resonant circuits with inductors (5) arranged at the edges of the glass.

9. Light modulator according to claim 6, characterized in that the phase of the waves in the circuits rotates around the light passage (3).

10. Light modulator according to claim 8, characterized in that the glass is shaped as a cylinder and that the antenna electrodes (4a, 4b) form a ring around the cylinder.

11. Device with a light modulator according to claim 1, characterized in that it is exposed to a laser beam (L), the modulated light of which is used in a messaging device with a light detector, or in a light recording device, a processing device or a projection device.

12. Device according to claim 11, characterized in that the modulated laser beam (L) is brought to an X- and Y-deflector (10, 11) which directs it to a projection area.

13. Device according to claim 12, characterized in that the deflector consists of two metallized prismatic cylinders (10, 11).

14. Device according claim 11, characterized in that several light modulators (M), are each exposed to a laser (R, G, B) of different a colour and that the resulting modulated laser beams (L) are superimposed and directed to the deflector (10, 11).

15. Device according to claim 14, characterized in that the lasers (R, G, B) emit light with a minimum of three primary colours.

16. Device according to claim 15, characterized in that each of the three lasers (R, G, B) is modulated according to one of the RGB signals of a video signal.

17. Device according to claim 14, characterized in that an additional light modulator (M) is exposed to a white light beam (H), which is modulated in accordance with a luminance signal.

18. Device according to claim 17, characterized in that the brightness of the projection is controlled by the intensity of the white light beam (H).

19. Device according to claim 17, characterized in that the white light beam (H) is created from a blue laser beam by transformation in a filter (F).
